(19) United States
(12) Patent Application Publication
(10) Pub. No.: US 2014/0320085 A1
(43) Pub. Date: Oct. 30, 2014

(54) CHARGING DEVICE AND CONTROL METHOD THEREOF

(71) Applicant: DYNAPACK INTERNATIONAL TECHNOLOGY CORPORATION, (US)

(72) Inventors: YING-YIN CHANG, TAOYUAN COUNTY (TW); BING-JOE HWANG, TAIPEI CITY (TW); HSIN-YI WANG, TAIPEI CITY (TW); JIUN-MING CHEN, TAOYUAN COUNTY (TW); YUN-CHIH LIN, TAOYUAN COUNTY (TW); FU-MING WANG, TAIPEI CITY (TW)

(73) Assignee: DYNAPACK INTERNATIONAL TECHNOLOGY CORPORATION, TAOYUAN COUNTY (TW)

(21) Appl. No.: 13/869,706

(22) Filed: Apr. 24, 2013

(51) Int. Cl. H02J 7/00

(52) U.S. Cl. CPC H02J 7/007
USPC 320/112; 320/162

(57) ABSTRACT

The present invention discloses a charging device electrically connected to an external power supply and a rechargeable battery pack, so as to perform a charging procedure of the rechargeable battery pack. The charging device includes a detecting module, a processing module and a charging module, wherein the processing module is electrically connected to the detecting module and the charging module. The detecting module is used for detecting both the state of charge of the rechargeable battery pack during the charging procedure and a polarization voltage corresponding to the internal resistance of the rechargeable battery pack at different states of charge. The processing module generates a current adjusting parameter according to the polarization voltage and the state of charge. The charging module receives the external power supply and adjusts the charging current outputted to the rechargeable battery pack according to the state of charge and the current adjusting parameter.

### BACKGROUND OF THE INVENTION

1. Field of the Invention

The present invention relates to a charging device and a control method thereof; in particular, to a charging device and a control method thereof, wherein the variation of internal resistance in a rechargeable battery pack is utilized to control the value of the charging current.

2. Description of Related Art

A traditional charging method for a rechargeable battery mainly includes a constant trickle current charging method, a constant current charging method and a constant current—constant voltage two-section charging method.

A charging device that uses a constant current—constant voltage two-section charging method is taken as an example. At first, the charging device utilizes a constant current to charge a rechargeable battery. When the rechargeable battery attains a preset voltage level, the charging device charges the rechargeable battery instead with a constant voltage that is equal to the preset voltage level, and lets the charging current be smaller gradually. When the charging current decreases to a preset threshold value, the charging device will determine that the rechargeable battery has attained a saturation state and stops charging.

When a rechargeable battery has been made in a factory, its internal resistance is relatively small. Therefore, when a rechargeable battery is charged by means of a traditional charging method, the rechargeable battery can attain a saturation state approaching 100%. However, accompanied with increased charging times of the rechargeable battery, the electrolytic solution within the rechargeable battery will exhaust gradually and the polarization phenomena of the positive and the negative electrodes become serious. At this moment, if the rechargeable battery is charged similarly by means of a traditional charging method, it will only result in enhancing the degradation speed of the positive, negative electrodes and the electrolytic solution within the rechargeable battery, furthermore the cycle count of the rechargeable battery is shortened.

### SUMMARY OF THE INVENTION

The object of the present invention is to provide a charging device, which adjusts the charging current outputted to a rechargeable battery pack at next charging time by detecting the state of charge (SOC) of the rechargeable battery pack and the polarization voltages at different states of charge, thus lets the polarization voltage converges gradually to a preset waveform.

In order to achieve the aforementioned object, according to an embodiment of the present invention, a charging device is provided, which is electrically connected to an external power supply and a rechargeable battery pack, so as to perform a charging procedure of the rechargeable battery pack, wherein the rechargeable battery pack includes at least one battery unit. The charging device includes a detecting module, a processing module and a charging module, wherein the charging module is electrically connected among the external power supply, the rechargeable battery pack and the processing module, while the detecting module is electrically connected between the rechargeable battery pack and the processing module. The detecting module is used for detecting both the state of charge of the rechargeable battery pack during the charging procedure and the polarization voltage corresponding to the internal resistance of the rechargeable battery pack at different states of charge. The processing module generates a current adjusting parameter according to the polarization voltage and the state of charge. The charging module receives an external power supply and adjusts the charging current outputted to the rechargeable battery pack according to the state of charge and the current adjusting parameter, so that the waveform of the polarization voltage conforms to a preset waveform.

The other object of the present invention is to provide a control method of a charging device, and in the control method the charging current outputted to a rechargeable battery pack at next charging time is adjusted by detecting the state of charge of the rechargeable battery pack and the polarization voltages at different states of charge, thus the polarization voltage may converge gradually to a preset waveform.

In order to achieve the aforementioned objects, according to an embodiment of the present invention, a control method of a charging device is provided, and the control method includes detecting the state of charge of the rechargeable battery pack during a charging procedure and the polarization voltages corresponding to the internal resistance of the rechargeable battery pack at different states of charge, wherein the rechargeable battery pack includes at least one battery unit. Next, a current adjusting parameter is generated according to the polarization voltage and the state of charge. Finally, the charging current outputted to the rechargeable battery pack is adjusted according to state of charge and the current adjusting parameter, so that the waveform of the polarization voltage conforms to a preset waveform.

Summing up the above, a charging device and a control method thereof are provided in the embodiments of the present invention, wherein a polarization voltage between the positive and the negative electrode within the rechargeable battery pack is determined at different states of charge by means of a galvanostatic intermittent titration technique, and suitable charging currents at different states of charge are determined according to the polarization voltage, so that the waveform of the polarization voltage conforms to a preset waveform.

In order to further the understanding regarding the present invention, the following embodiments are provided along with illustrations to facilitate the disclosure of the present invention. However, such embodiments are used only for illustration of the present invention and not for restricting the claims thereof.

### BRIEF DESCRIPTION OF THE DRAWINGS

FIG. 1 shows a functional block diagram of a charging device according to an embodiment of the present invention;

FIG. 2 shows a voltage timing diagram of a rechargeable battery pack when a charging procedure is performed at the first time according to an embodiment of the present invention;

FIG. 3 shows polarization voltage, charging current, and state of charge schematic diagram of a rechargeable battery pack when a charging procedure is performed at first time according to an embodiment of the present invention;

FIG. 4A shows polarization voltage, charging current, and state of charge schematic diagram of a rechargeable battery pack after first calibration is performed according to an embodiment of the present invention.

FIG. 4B shows polarization voltage, charging current, and state of charge schematic diagram of a rechargeable battery pack after second calibration is performed according to an embodiment of the present invention.

FIG. 5 shows an efficiency schematic diagram of a traditional charging procedure and a charging procedure performed by using the charging device of the present invention for a rechargeable battery pack.

FIG. 6A shows polarization voltage, charging current, and state of charge schematic diagram of a rechargeable battery pack according to another embodiment of the present invention;

FIG. 6B shows polarization voltage, charging current, and state of charge schematic diagram of a rechargeable battery pack according to further another embodiment of the present invention;

FIG. 7 shows a flow chart of the control method of a charging device according to another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

[Embodiment of a Charging Device]

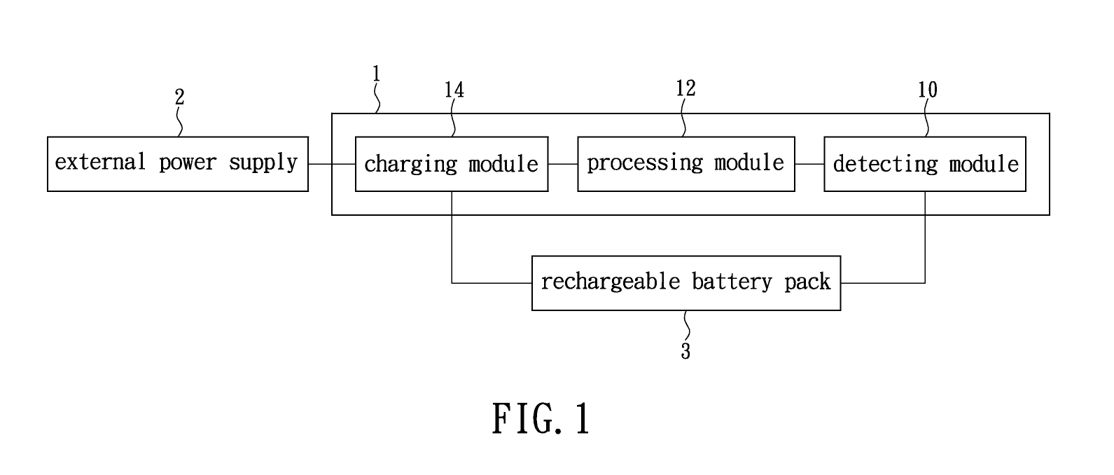

Please refer to FIG. 1. FIG. 1 shows a functional block diagram of a charging device according to an embodiment of the present invention. As shown in FIG. 1, the charging device 1 is electrically connected between an external power supply 2 and a rechargeable battery pack 3, so as to perform the charging procedure of the rechargeable battery pack 3. The charging device 1 includes a detecting module 10, a processing module 12 and a charging module 14, wherein the charging module 14 is electrically connected among the external power supply 2, the rechargeable battery pack 3 and the processing module 12, while the detecting module 10 is electrically connected between the rechargeable battery pack 3 and the processing module 12.

Generally speaking, the external power supply 2 may be, for example, an AC power supply provided by a commercial power, or an AC power supply generated by a generator, or a DC power supply. Of course, a person skilled in the art may view the external power supply 2 as a DC power supply outputted by a host device (for example, a desktop computer or a notebook) via a universal serial bus (USB) interface. The external power supply 2 of the present invention is not limited thereto.

The rechargeable battery pack 3 includes at least one battery unit (not shown in FIG. 1). In other words, two or more battery units may be connected in series or in parallel to form the rechargeable battery pack 3. The used number and the connection type of the battery units are not limited in the present invention. In practice, the battery unit may be an accumulator such as a lithium-ion battery, a nickel-hydrogen battery, a nickel-cadmium battery or a lead storage battery, and is not limited thereto in the present invention. Each functional module in the charging device 1 is respectively described in detail as follows.

The detecting module 10 is used for detecting the state of charge (SOC) of the rechargeable battery pack 3 during a charging procedure and the polarization voltage corresponding to the internal resistance of the rechargeable battery pack 3 at each state of charge. The detecting module 10 mainly includes a charge detecting unit and a voltage detecting unit.

Here, it should be mentioned at first that the state of charge of the rechargeable battery pack 3 in an embodiment of the present invention may also be called as a charging level or a residual charge of the rechargeable battery pack 3. To explain in more detail, the state of charge is the charge contained in the rechargeable battery pack 3 at present, and is generally represented as a percentage. That the state of charge is 100% represents that the rechargeable battery pack 3 is fully charged. That the state of charge is 0% represents that the rechargeable battery pack 3 is fully discharged. The polarization voltage indicated in the embodiment of the present invention represents a difference between an open circuit voltage (OCV) and a charging voltage in a charging procedure performed by the rechargeable battery pack 3. Therefore, the polarization voltage may also be called as a voltage drop of the rechargeable battery pack 3. In addition, the open circuit voltage represents a potential difference (also called as a voltage difference) between a positive and a negative electrode of the rechargeable battery pack 3 when the rechargeable battery pack 3 is not in a charging/discharging state. Therefore, the open circuit voltages of different rechargeable battery packs 3 are different because the materials used in the positive electrodes, the negative electrodes and the electrolytic solution are different.

The charge detecting unit is used for detecting a charge variation when the rechargeable battery pack 3 performs a charging procedure, so as to obtain the state of charge of the rechargeable battery pack 3. In practice, the charge detecting unit can perform a measure by means of an open circuit measure method, an electrolytic solution specific gravity measure method, a load voltage measure method, a battery internal resistance measure method or a coulometer (also called as a charge meter or a charge instrument) measure method. The measure method of the present invention is not limited thereto, and the measure methods described above are traditional measure methods in this technical field, so their descriptions are omitted here.

The voltage detecting unit is used for detecting the polarization voltage corresponding to the internal resistance of the rechargeable battery pack 3 at different states of charge. To explain in more detail, because the internal resistance of the rechargeable battery pack 3 will change according to the level of the state of charge of the rechargeable battery pack 3, the internal resistances at different states of charge are different, thus the polarization voltage is also changed according to the internal resistance of the rechargeable battery pack 3. In other words, when the voltage detecting unit detects the polarization voltage of the rechargeable battery pack 3 at each state of charge, the voltage detecting unit can also obtain the internal resistance at said state of charge. In practice, the voltage detecting unit may be an ohmmeter (also called as a resistance meter), a voltmeter or a multimeter, and is not limited thereto in the present invention.

The processing module 12 generates a set of current adjusting parameter according to the polarization voltage and the state of charge. The current adjusting parameter indicates correspondingly a charging current poured into the rechargeable battery pack 3. In addition, the processing module 12 further includes a memory unit, which may be a RAM, a ROM or a flash memory, for storing the current adjusting parameter. In practice, the processing module 12 may be a micro-controller or a CPU, and is not limited thereto in the present invention.

The charging module 14 receives a power provided by the external power supply 2 and adjusts the charging current outputted to the rechargeable battery pack 3 according to the current adjusting parameter and the state of charge, so that the waveform of the polarization voltage conforms to a preset waveform. In other words, the charging module 14 can output a charging current of different value according to a to-be-outputted power indicated by the current adjusting parameter, and then the current value of the charging current is dynamically adjusted, so as to charge energy to the rechargeable battery pack 3.

In practice, the charging module 14 may be a converter, a chopper or their combination. For example, if the external power supply 2 is an AC power supply, the charging module 14 will include a set of AC/DC converter used for changing a current waveform and a set of DC chopper used for adjusting the value of the charging current. As for a person skilled in the art, a circuit corresponding to the operation of the charging module 14 can be directly designed according to practical condition of the external power supply 2 and the rechargeable battery pack 3.

To explain in more detail, in a practical operation when a charging procedure of the rechargeable battery pack 3 is performed by the charging device 1 of the present invention, commercial 18650-2.6 Ah batteries are always used in the rechargeable battery pack 3. The rechargeable battery pack 3 of such type is a lithium battery, the capacitance of which is about 2600 mA. It is worth noting that the state of charge of the rechargeable battery pack 3 is taken as a division interval of performing a charging procedure in an embodiment of the present invention. To explain in more detail, the state of charge of the rechargeable battery pack 3 in the embodiment of the present invention takes each 2% as an interval, but the interval is not limited thereto. The person skilled in the art may divide an interval of different ratio according to the practical condition of the rechargeable battery pack 3. In addition, the open circuit voltages of different rechargeable battery packs 3 are always different. The waveforms in the following figures are used only for illustration and not for restricting the waveforms of the charging batteries in an embodiment of the present invention.

It is worth noting that when a charging procedure is performed at first time in the rechargeable battery pack 3, at the start the charging module 14 will perform to the rechargeable battery pack 3 a constant current charging with a set of preset current. Furthermore, the value of the charging current is defined according to the capacitance of the rechargeable battery pack 3 and C (capacity) is acted as a measure unit of the charging current. For example, when the capacitance of the rechargeable battery pack 3 (commercial 18650 batteries) in the embodiment of the present invention is 2600 mA, i.e., the charging current is 2600 mA/h, a total charging time of only one hour is enough to charge the rechargeable battery pack 3 to saturation, and C is 2600 mA. In an embodiment of the present invention, a constant current charging is performed with a preset current of 0.7 C. In other words, in the embodiment of the present invention the total charging time is about 90 minutes when the rechargeable battery pack 3 performs a charging procedure at first time.

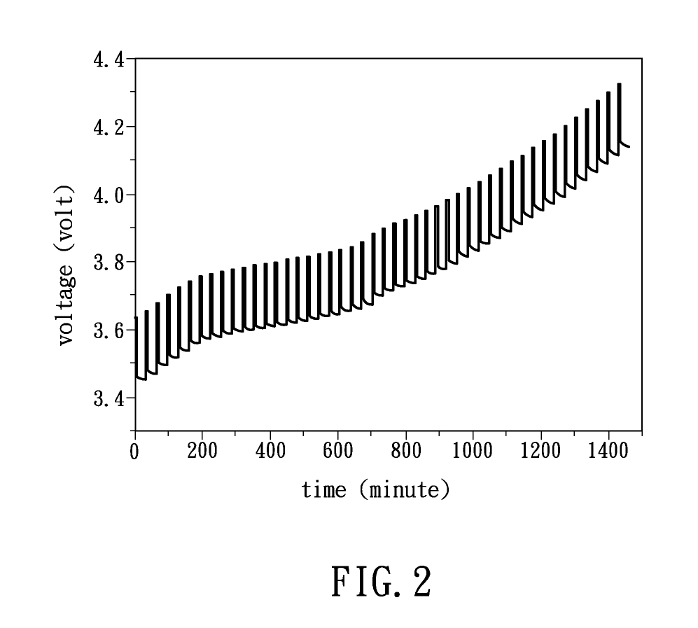

Please refer to FIG. 2. FIG. 2 shows a voltage timing diagram of a rechargeable battery pack when a charging procedure is performed at the first time according to an embodiment of the present invention. As shown in FIG. 2, when the rechargeable battery pack 3 performs a charging procedure at the first time, due to the fact that the detecting module 10 needs to detect the polarization voltage of the rechargeable battery pack 3 at different states of charge, the charging module 14 will pause for a section of preset time when charging to a state of charge of each 2% interval, so that the detecting module 10 can accurately detect the polarization voltage in this interval. In an embodiment of the present invention, the preset time is 30 minutes. A person skilled in the art can directly design a reasonable preset time according to practical condition, and the preset time is not limited thereto in the present invention.

To explain in more detail, the X axis in the voltage timing diagram shown in FIG. 2 represents time (minute), and Y axis represents voltage (volt V), while the peak value in the voltage timing diagram is a charging voltage of each 2% state of charge, and the valley value in the voltage timing diagram is an open circuit voltage of each 2% state of charge, wherein the difference value thereof is the polarization voltage (also called as a voltage drop) of the 2% state of charge. In other words, when the rechargeable battery pack 3 performs a charging procedure at the first time, an interval charging mode is adopted to obtain the internal resistance of the rechargeable battery pack 3 at each 2% state of charge. In practice, the technique used to measure the internal resistance at each state of charge is called as a galvanostatic intermittent titration technique, GITT).

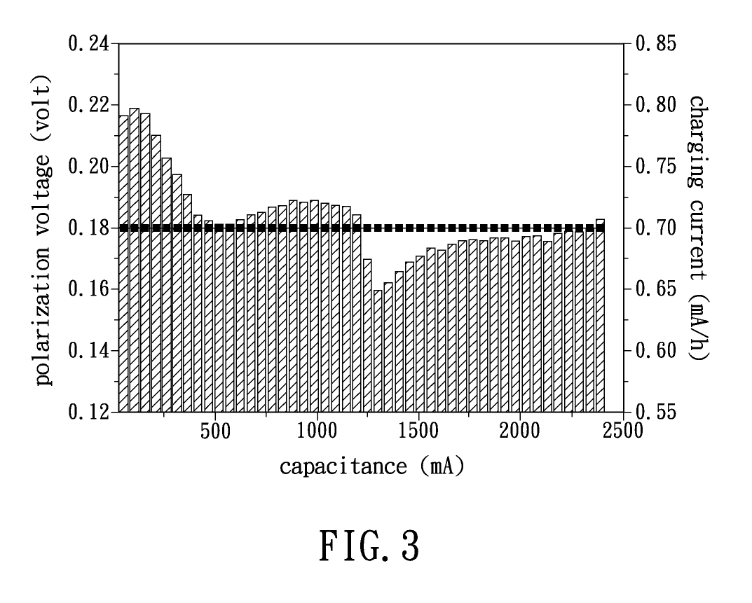

Next, the polarization voltages of each 2% state of charge are collected one by one, and such data is plotted as a schematic diagram based on the state of charge, as shown in FIG. 3. FIG. 3 shows polarization voltage, charging current, and state of charge schematic diagram of a rechargeable battery pack when a charging procedure is performed at first time according to an embodiment of the present invention. The X axis in FIG. 3 represents a capacitance, and each interval at the X axis represents each 2% state of charge, while the vertical strips and the broken line at the Y axis represent respectively the polarization voltage and the charging current at each 2% state of charge.

As can be clearly observed from FIG. 3, when a constant current charging is performed at a preset current of 0.7 C, the polarization voltage will change according to different state of charge of the rechargeable battery pack 3. The interval of a higher polarization voltage represents that the internal resistance of the rechargeable battery pack 3 at this state of charge is relatively high. Therefore, when a charging procedure is performed at this state of charge, the charging is more suitable to be performed with a smaller charging current, so as to attain a condition of decreasing the polarization in the rechargeable battery pack 3. On the contrary, the interval of a lower polarization voltage represents that the internal resistance of the rechargeable battery pack 3 at this state of charge is relatively low. Therefore, when a charging procedure is performed at this state of charge, the charging may be performed with a larger charging current, so as to shorten the charging time at this state of charge. Moreover, the average value of adjusted charging current at each 2% state of charge must be set to be equal to a preset current, so that the total charging time maintains unchanged.

In addition, the charging current and the polarization voltage shows a linear ratio relationship. In an embodiment of the present invention, the charging speed is increased (or decreased) 1C each time, then the polarization voltage will increase (or decrease) 0.24V, thus the processing module 12 can generate a set of current adjusting parameter at each 2% state of charge.

At each 2% state of charge, the used charging current=a preset current−(polarization voltage at this state of charge−average polarization voltage)/(the linear ratio of the charging current and the polarization voltage), and the calculated current adjusting parameter is applied to a charging procedure performed at the next time in the rechargeable battery pack 3. In an embodiment of the present invention, the used charging current at each 2% state of charge=0.7−(the polarization voltage at this state of charge−0.18)/0.24. In other words, because the state of charge of the rechargeable battery pack 3 has been divided into several intervals, the processing module 12 may generate a set of current adjusting parameter according to the polarization voltage at each interval.

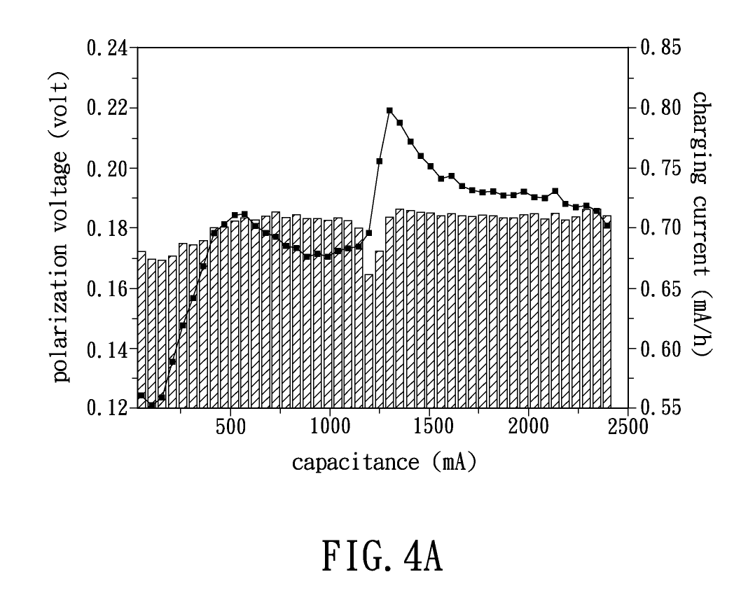

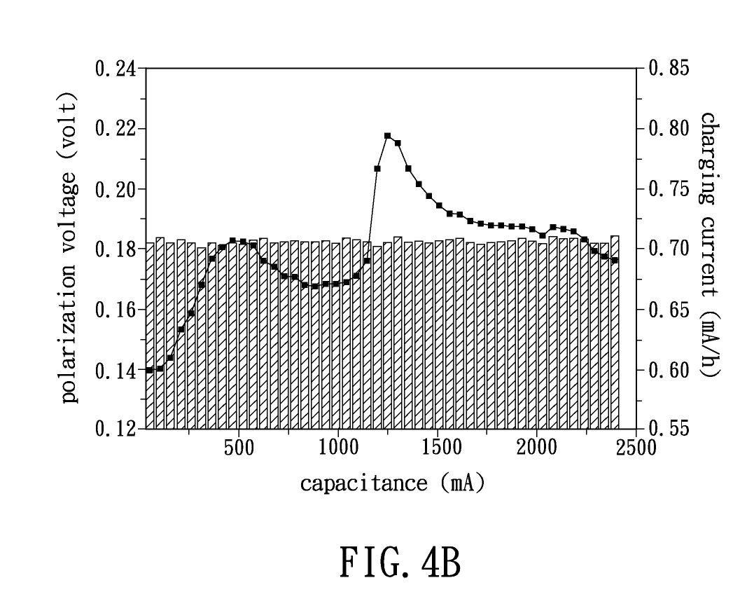

Please refer to FIG. 3 and FIG. 4A together. FIG. 4A shows polarization voltage, charging current, and state of charge schematic diagram of a rechargeable battery pack after first calibration is performed according to an embodiment of the present invention. As can be seen clearly from FIG. 4A, the charging module 14 may adjust the value of the charging current of the rechargeable battery pack 3 at each state of charge by means of the calibration of the current adjusting parameter, so that the polarization voltage at each state of charge tends gradually to equilibrium.

Next, the processing module 12 generates the next set of current adjusting parameter according to the polarization voltage at each state of charge after the first calibration, as shown in FIG. 4B. FIG. 4B shows polarization voltage, charging current, and state of charge schematic diagram of a rechargeable battery pack after second calibration is performed according to an embodiment of the present invention. As can be seen more clearly from FIG. 4B, after twice calibration, the polarization voltage at each state of charge will converge more clearly to an average polarization voltage, so that the waveform of the polarization voltage becomes a waveform fixed in a voltage range. All the following calibrations are identical to the above (this is a trial-and-error method) and will not be described here.

Besides, as can be clearly seen from FIG. 3, FIG. 4A and FIG. 4B, if the waveform of the polarization voltage of the rechargeable battery pack 3 at a state of charge of a certain interval is higher than a preset waveform, the outputted charging current will be decreased when the charging module 14 performs at next time a charging procedure at a state of charge of this interval. If the waveform of the polarization voltage of the rechargeable battery pack 3 at a state of charge of a certain interval is lower than a preset waveform, the outputted charging current will be increased when the charging module 14 performs at next time a charging procedure at a state of charge of this interval, thus the waveform of the polarization voltage may converge gradually to the preset waveform.

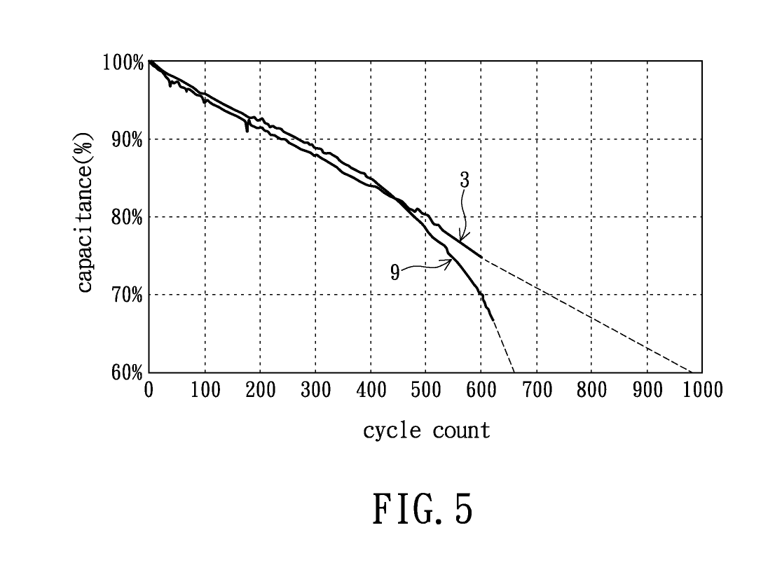

Please refer to FIG. 5. FIG. 5 shows an efficiency schematic diagram of a traditional charging procedure and a charging procedure performed by using the charging device of the present invention for a rechargeable battery pack. The X axis in FIG. 5 represents cycle counts of the rechargeable battery pack, and the cycle counts can also be called as charging/discharging counts, while the Y axis represents capacitance percentages of the rechargeable battery pack 3.

As shown in FIG. 5, the charging procedure of the rechargeable battery pack 3 is performed by the charging device of the present invention, and when the residual capacitance is 70%, the life time is increased with an amount of 110 cycle counts compared with a traditional constant current-constant voltage charging method used in a rechargeable battery pack 9, while at a residual capacitance of 60% the life time is increased with an amount of 300 cycle counts. In other words, the degradation speed of the positive and the negative electrode materials of the rechargeable battery pack 3 is decreased when the charging procedure is performed by the charging device of the present invention, and furthermore a functional significant decay of the rechargeable battery pack 3 is avoided.

In addition, the charging device 1 of the present invention may generate a corresponding current adjusting parameter according to the temperature of the rechargeable battery pack 3 and the value of cycle count, and then the object of extending the cycle count of the rechargeable battery pack 3 is attained.

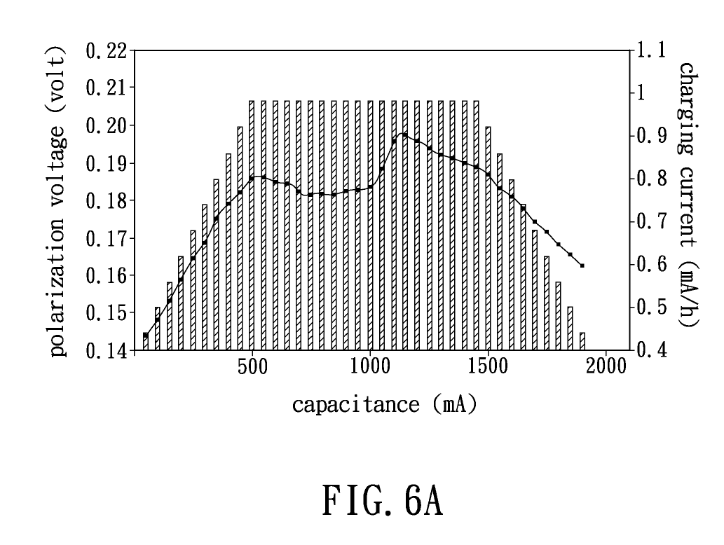

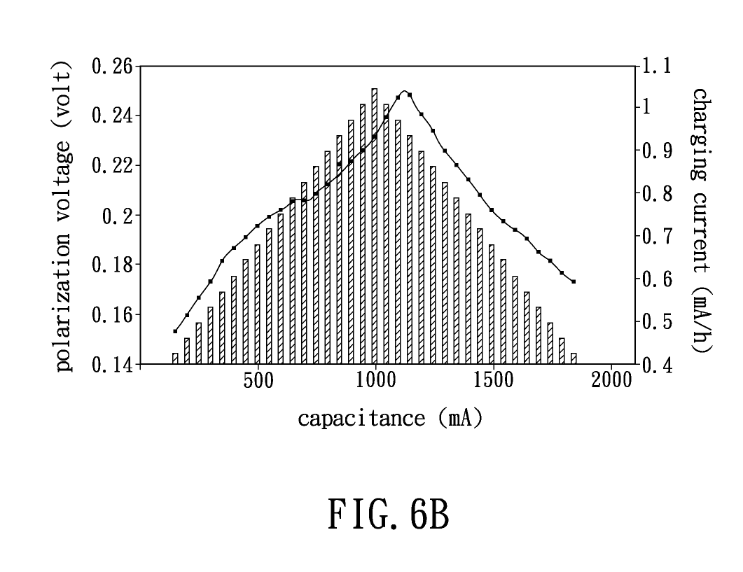

It is worth noting that although the preset waveform in the embodiment of the present invention is a constant-voltage waveform, the waveform of the preset waveform is not limited thereto in the present invention. Please refer to FIG. 6A and FIG. 6B. FIG. 6A shows polarization voltage, charging current, and state of charge schematic diagram of a rechargeable battery pack according to another embodiment of the present invention; FIG. 6B shows polarization voltage, charging current, and state of charge schematic diagram of a rechargeable battery pack according to further another embodiment of the present invention.

As shown in FIG. 6A, if we wish to let the preset waveform become a trapezoid, the charging device 1 may adjust the charging current outputted to the rechargeable battery pack 3 at different state of charge according to the current adjusting parameter and the state of charge, so that the waveform of the polarization voltage of the rechargeable battery pack 3 at different state of charge attains a trapezoid. Similarly, as shown in FIG. 6B, if we wish to let the preset waveform become a triangle, the waveform of the polarization voltage of the rechargeable battery pack 3 at different state of charge may attain a triangle by means of the charging device 1 of the present invention. Therefore, a person skilled in the art can directly set the desired waveform of the polarization voltage of the rechargeable battery pack 3 according to practical using condition.

[Embodiment of the Control Method of a Charging Device]

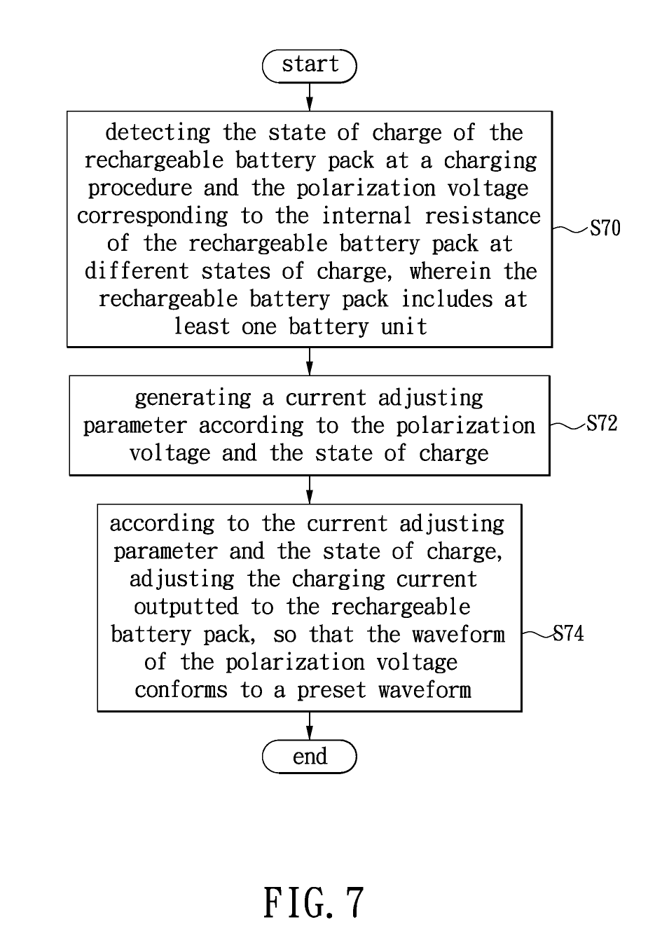

Please refer to FIG. 1 and FIG. 7 together. FIG. 7 shows a flow chart of the control method of a charging device according to another embodiment of the present invention. The charging device 1 used in the control method performs a charging procedure by receiving an external power supply 2, then the charging current of different value is outputted adjustably to the rechargeable battery pack 3. As shown in FIG. 7, in step S70, the charging device 1 detects the state of charge of the rechargeable battery pack at a charging procedure and the polarization voltage corresponding to the internal resistance of the rechargeable battery pack at different states of charge, wherein the rechargeable battery pack includes at least one battery unit.

Next, in step S72, the charging device 1 generates a set of current adjusting parameter according to the polarization voltage and the state of charge. Finally, in step S74, the charging device 1 adjusts the charging current outputted to the rechargeable battery pack according to the current adjusting parameter and the state of charge, so that the waveform of the polarization voltage conforms to a preset waveform, and the step is back to S70 when the charging procedure is performed at next time, and other steps are performed similarly.

It is worth noting that the state of charge of the rechargeable battery pack 3 is divided into several intervals, so that the charging device 1 can generate the current adjusting parameter according to the polarization voltage of each interval. To explain in more detail, if the waveform of the polarization voltage of the rechargeable battery pack 3 at a state of charge of a certain interval is higher than the preset waveform, the charging device 1 will decrease the outputted charging current when at next time the charging procedure is performed at this state of charge. If the waveform of the polarization voltage of the rechargeable battery pack 3 at a state of charge of a certain interval is lower than the preset waveform, the charging device 1 will increase the outputted charging current when at next time the charging procedure is performed at this state of charge, so that the waveform of the polarization voltage at the state of charge of this interval may converge gradually to a preset waveform.

In addition, when the rechargeable battery pack 3 performs a charging procedure at first time, the charging device 1 performs a constant current charging of the rechargeable battery pack 3 by means of the preset current. Besides, the preset waveform is a waveform fixed in a voltage range. In other words, the waveform of the polarization voltage may be a constant-voltage waveform. Of course, a person skilled in the art may change the waveform of the polarization to a trapezoid, a triangle or a horizontal waveform (also called as a stable waveform), and the waveform of the present invention is not limited thereto.

In practice, the control method of a charging device in the present invention may further be applied to electric bicycles or power generation of regeneration energy source (for example, solar energy or wind power). To explain in detail, a device that can charge the current back to a battery jar during braking has been installed at an electric bicycle in market. If combined with the control method of a charging device in the present invention, the charging device will adjust the value of the charging-back current during braking according to the state of the battery jar at present, so as to effectively enhance the endurance of the electric bicycle and extend the life time of the battery jar. If applied to the power generation of regeneration energy source, the power generation device of regeneration energy source may adjust selectively the power generation peak value of the power generation device of regeneration energy source according to internal resistance condition of energy-storing batteries, and furthermore the energy-storing efficiency of the regeneration energy source is effectively enhanced and the life time of the energy-storing batteries is extended.

[Possible Efficacy of Embodiments]

Summing up the above, a charging device and a control method thereof are provided in the embodiments of the present invention, wherein a polarization voltage between the positive and the negative electrode within the rechargeable battery pack is determined at different states of charge by means of a galvanostatic intermittent titration technique, and suitable charging currents at different states of charge are determined according to the polarization voltage, so that the waveform of the polarization voltage conforms to a preset waveform. Therefore, the charging device and the control method thereof of the present invention may increase the cycle count of the rechargeable battery pack, furthermore the user may rapidly charge the rechargeable battery pack, and the demand of a much longer life time may be attained.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A charging device, electrically connected to an external power supply and a rechargeable battery pack, so as to perform a charging procedure of the rechargeable battery pack, wherein the rechargeable battery pack includes at least one battery unit, the charging device comprising:
a detecting module, used for detecting both the state of charge of the rechargeable battery pack during the charging procedure and a polarization voltage corresponding to the internal resistance of the rechargeable battery pack at different states of charge;
a processing module, electrically connected to the detecting module and generating a current adjusting parameter according to the polarization voltage and the state of charge; and
a charging module, electrically connected among the external power supply, the rechargeable battery pack and the processing module, the charging module receiving the external power supply and adjusting the charging current outputted to the rechargeable battery pack according to the state of charge and the current adjusting parameter, so that the waveform of the polarization voltage conforms to a preset waveform.

2. The charging device according to claim 1, wherein the state of charge of the rechargeable battery pack is divided into several intervals, and wherein the processing module generates the current adjusting parameter according to the polarization voltage of each interval.

3. The charging device according to claim 1, wherein the charging module performs a constant current charging of the rechargeable battery pack by means of a preset current when the rechargeable battery pack performs the charging procedure at first time.

4. The charging device according to claim 1, wherein the preset waveform is a waveform fixed in a voltage range.

5. The charging device according to claim 1, wherein the preset waveform is a trapezoid, a triangle or a horizontal waveform.

6. The charging device according to claim 1, wherein if the waveform of the polarization voltage of the rechargeable battery pack at a state of charge of a certain interval is higher than the preset waveform, the outputted charging current will be decreased when the charging module performs at next time the charging procedure at a state of charge of this interval; if the waveform of the polarization voltage of the rechargeable battery pack at a state of charge of a certain interval is lower than the preset waveform, the outputted charging current will be increased when the charging module performs at next time the charging procedure at a state of charge of this interval.

7. A control method of a charging device, including:
detecting the state of charge of the rechargeable battery pack during a charging procedure and the polarization voltages corresponding to the internal resistance of the rechargeable battery pack at different states of charge, wherein the rechargeable battery pack includes at least one battery unit;
generating a current adjusting parameter according to the polarization voltage and the state of charge; and
adjusting a charging current outputted to the rechargeable battery pack according to the state of charge and the current adjusting parameter, so that the waveform of the polarization voltage conforms to a preset waveform.

8. The control method according to claim 7, wherein the state of charge of the rechargeable battery pack is divided into several intervals, and wherein the processing module generates the current adjusting parameter according to the polarization voltage of each interval.

9. The control method according to claim 7, wherein the charging module performs a constant current charging of the rechargeable battery pack by means of a preset current when the rechargeable battery pack performs the charging procedure at first time.

10. The control method according to claim 7, wherein the preset waveform is a waveform fixed in a voltage range.

11. The control method according to claim 7, wherein the preset waveform is a trapezoid, a triangle or a horizontal waveform.

12. The control method according to claim 7, wherein if the waveform of the polarization voltage of the rechargeable battery pack at a state of charge of a certain interval is higher than the preset waveform, the outputted charging current will be decreased when the charging module performs at next time the charging procedure at a state of charge of this interval; if the waveform of the polarization voltage of the rechargeable battery pack at a state of charge of a certain interval is lower than the preset waveform, the outputted charging current will be increased when the charging module performs at next time the charging procedure at a state of charge of this interval.
